(19) United States
(12) Patent Application Publication
(10) Pub. No.: US 2013/0117056 A1
(43) Pub. Date: May 9, 2013

(54) TECHNIQUES TO PROVIDE ENTERPRISE RESOURCE PLANNING FUNCTIONS FROM A CUSTOMER RELATIONS MANAGEMENT CLIENT APPLICATION

(71) Applicants: Mirza Abdic, (US); Denys Kukurudza, (US); Ivan Kashperuk, (US); Volodymyr Giginiak, (US); Dmytro Sitnik, (US); Vyacheslav Chernenko, (US); Alexander Malafeev, (US); Ievgenii Korovin, (US)

(72) Inventors: Mirza Abdic, (US); Denys Kukurudza, (US); Ivan Kashperuk, (US); Volodymyr Giginiak, (US); Dmytro Sitnik, (US); Vyacheslav Chernenko, (US); Alexander Malafeev, (US); Ievgenii Korovin, (US)

(73) Assignee: MICROSOFT CORPORATION, Redmond, WA (US)

(21) Appl. No.: 13/292,319

(22) Filed: Nov. 9, 2011

(51) Int. Cl. G06Q 10/06

(52) U.S. Cl. 705/7.12

(57) ABSTRACT

Techniques and apparatuses for providing access to enterprise resource planning (ERP) systems from CRM applications are described. In an embodiment, an apparatus includes a processing unit and a client CRM application executing on the processing unit. An add-on application may be installed on the client CRM application. The add-on application allows the client CRM application to receive an ERP action from an ERP system via a supply hub; act on the ERP action with a second ERP action; and send the second ERP action to the ERP system via the supply hub. Other embodiments are described and claimed.

### RELATED APPLICATIONS

This application is related to commonly owned and assigned U.S. application Ser. No. ______, titled “Techniques to Provide Enterprise Resource Planning Functions From an Email Client Application,” filed Nov. ______, 2001.

### BACKGROUND

Many entities, such as businesses, have supply relationships with other entities. That is, many entities operate, at least in part, by buying and selling products and services from and to other entities. Some entities manage their supply relationships by exchanging business information from one computer system at one entity to another computer system at another entity using an electronic data interchange (EDI) system. EDI systems may be expensive, complicated and slow to implement. Some entities avoid EDI systems by exchanging information via telephone, facsimile, or mail. It is with respect to these and other considerations that the present improvements have been needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to techniques to provide access to an enterprise resource planning (ERP) application's functions via an add-on to an existing customer relations management (CRM) application used by a client. Some embodiments are particularly directed to techniques to provide access to an ERP system using a cloud computing model. Embodiments may provide access to ERP systems from a client application add-on without using an electronic data interchange (EDI) system. In one embodiment, for example, an apparatus may comprise a processing unit and a client CRM application executing on the processing unit. The apparatus may further comprise an add-on application installed on the client CRM application. The add-on client may be operative to receive an ERP action from an ERP system via a supply hub; act on the ERP action with a second ERP action; and send the second ERP action to the ERP system via the supply hub. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of a first system for providing ERP functions from a CRM client application.

FIG. 2 illustrates an embodiment of a second system for providing ERP functions from a CRM client application.

FIG. 3 illustrates an embodiment of a supply hub.

FIG. 4 illustrates an embodiment of a client system.

FIG. 5 illustrates a sequence diagram of an ERP-client interaction.

FIG. 6 illustrates a first user interface for an add-on application.

FIG. 7 illustrates a second user interface for an add-on application.

FIG. 8 illustrates a third user interface for an add-on application.

FIG. 9 illustrates an embodiment of a logic flow for providing ERP functions from a CRM client application.

FIG. 10 illustrates an embodiment of a computing architecture.

FIG. 11 illustrates an embodiment of a communications architecture.

### DETAILED DESCRIPTION

Various embodiments are directed to systems and techniques to manage supply relationships electronically and automatically. One entity, e.g. a customer, may operate an enterprise resource planning (ERP) system. The entity may provide an add-on client application that may be installed as a component to an existing customer relations management (CRM) application at the client, e.g. a vendor. The vendor does not need to purchase additional software, or set up and maintain an electronic data interchange (EDI) system with the customer. The client may interact with the ERP system, e.g. receiving and confirming orders, from the add-on application functionality within the existing CRM application. An embodiment allows key performance indicators (KPIs) and vendor managed inventory (VMI) to be tracked and viewed. As a result, the embodiments can improve affordability, scalability, modularity, extendibility, or interoperability for an operator, device or network.

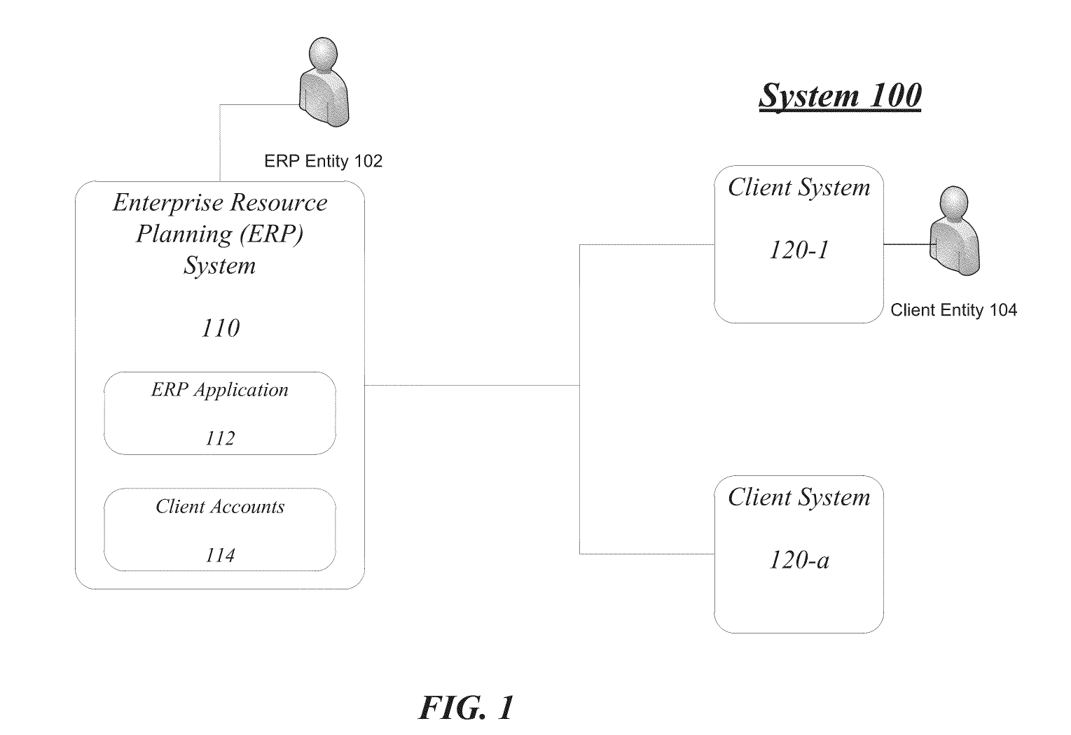

FIG. 1 illustrates a block diagram for a system 100 to provide access to an enterprise resource planning application from client systems. In one embodiment, for example, the system 100 may comprise a computer-implemented system 100 having multiple components, such as an ERP system 110, and client systems 120-1, 120-a, where a is a positive integer. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented with one or more electronic devices. Examples of an electronic device may include, without limitation, a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

In various embodiments, the system 100 may comprise enterprise resource planning (ERP) system 110. In an embodiment, ERP system 110 may be owned by an ERP entity 102, such as a business or government agency, and may include one or more ERP applications 112 operating on one or more electronic devices, e.g. servers. An ERP application 112 may include programming instructions that, when executed on a logic device or processing unit, perform functions that help a business entity manage various aspects of the business. For example, an ERP application 112 may manage inventory, receive orders from customers for products in the inventory, fulfill orders by shipping the ordered products to the customer, receive payments from the customer, manage employee scheduling, order products from vendors, pay vendors for received products, and so forth. The embodiments are not limited to these examples.

An ERP application 112 may enforce various business processes within the entity and during transactions with external parties, such as vendors and customers. For example, a business process may specify what information in an order is necessary. An ERP application 112 may also provide project planning and management functions, human resources management, customer relations management, and so forth. Example of ERP applications 112 include, without limitation, MICROSOFT DYNAMICS AX® from MICROSOFT® CORP., SAP BUSINESS SUITE® from SAP®, and ORACLE E-BUSINESS SUITE® from ORACLE®.

ERP application 112 may receive and respond to control directives from an ERP entity 102 via a suitable GUI and various input/output (I/O) devices, such as input from an input device that causes ERP application 112 to perform an ERP action.

In various embodiments, ERP system 110 may also include client accounts 114. Client accounts 114 may include information that is associated with a client entity, such as a particular vendor or customer. Client accounts 114 may include, for example, identifying information for a client, such as name, address, telephone number, a unique client identifier, and so forth. Client accounts 114 may also include access credentials for a client to use when accessing ERP system 110 from a client system, e.g. client system 120-1. Client accounts 114 may also include information that describes a system that the client is using to access ERP system 110, e.g. what application is used, platform, version number, operating system and so forth.

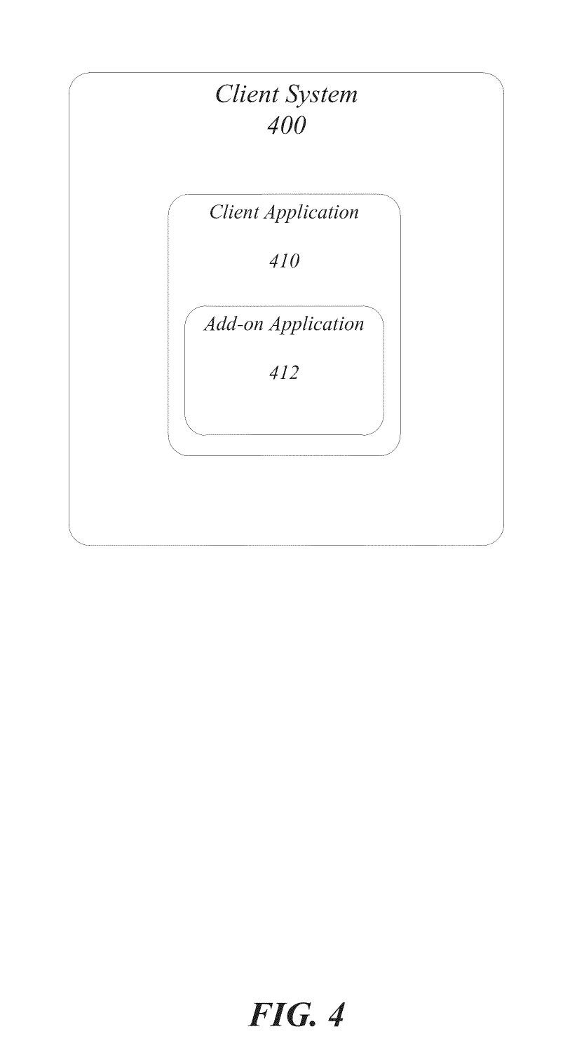

In various embodiments, the system 100 may include one or more client systems, such as client systems 120-1 to 120-a, where a represents a positive integer. Client system 120 may include one or more electronic devices owned by a client entity 104, such as a vendor, a purchaser, a customer, a government agency, and so forth. The client entity 104 may have repeated or ongoing interactions and/or transactions with the ERP entity 102. An example of a client system 120 is described further with respect to FIG. 4. A client system 120 may receive and respond to control directives from a client entity 104 via a suitable GUI and various input/output (I/O) devices, such as input from an input device that causes client system 120 to perform an ERP action.

In an embodiment, client systems 120 may be communicatively coupled to ERP system 110, for example, over a network (not shown) such as, but not limited to, the Internet. ERP system 110 may provide a network address to a client system 120 to use to connect to and interact with ERP system 110. The embodiments are not limited to these examples.

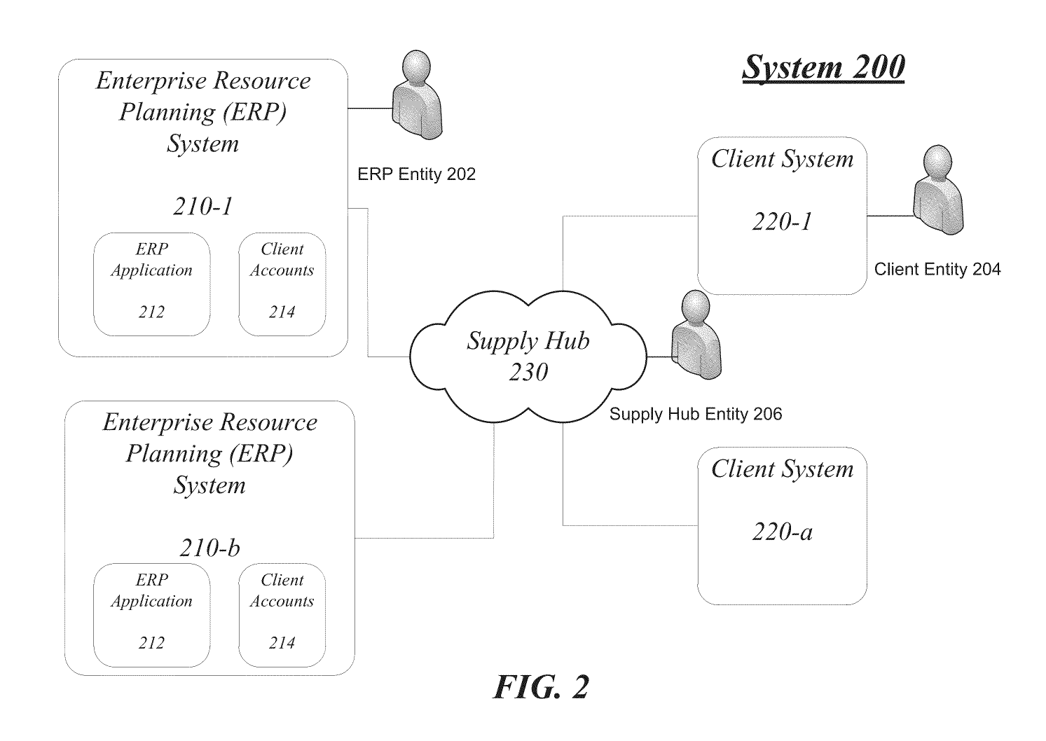

FIG. 2 illustrates a block diagram of a system 200 to provide access to an enterprise resource planning application from client systems. System 200 may be similar to the system 100, in that ERP systems 210-1 and 210-b, where b represents a positive integer, may be representative embodiments of ERP system 110 and client systems 220 may be representative embodiments of client systems 120. ERP application 212 and client accounts 214 may be representative embodiments of ERP application 112 and client accounts 114, respectively. Client entity 204 may be representative of client entity 104.

System 200 may further comprise a supply hub 230. Supply hub 230 may represent a logical construct that can send, receive, and operate on ERP related data in communication with ERP systems 210 and client systems 220. Supply hub 230 may include, for example, servers and data stores. Supply hub 230 may be owned by a supply hub entity 206 and operated on behalf of another entity, such as ERP entity 202.

System 200 may further comprise a plurality of ERP systems, e.g. ERP system 210-1 and ERP system 210-b. In an embodiment, the plurality of ERP systems 210 may be owned by the same entity, e.g. ERP entity 202, but may be located in different physical locations. In such an embodiment, the plurality of ERP systems 210 may interact with the same ERP data on supply hub 230.

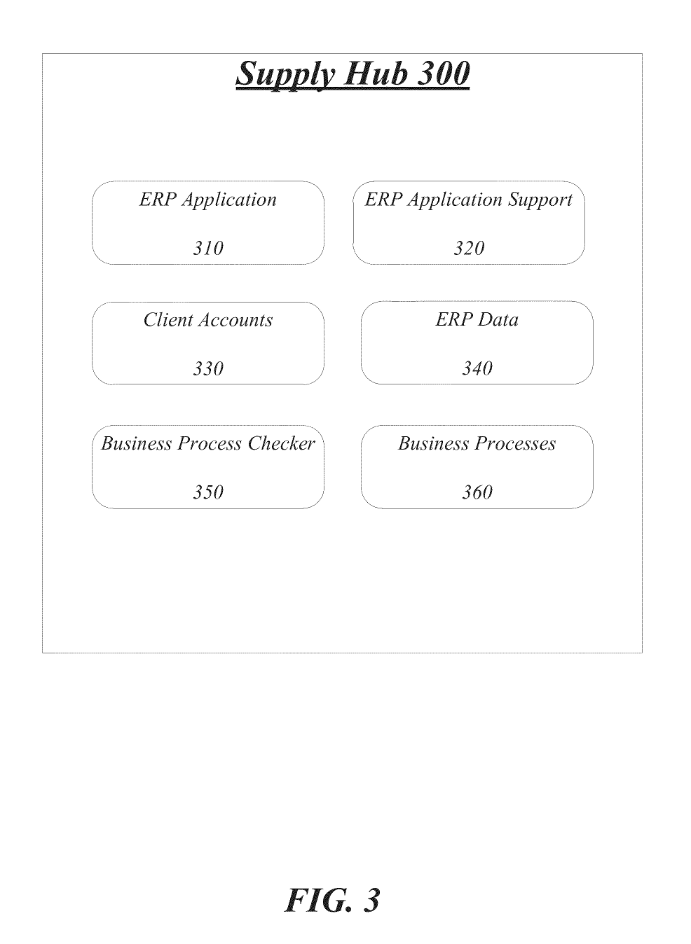

In an embodiment, the plurality of ERP systems 210 may be owned and operated by different entities. For example, ERP entity 202 may own ERP system 210-1, and company B (not shown) may own ERP system 210-b. In such an embodiment, supply hub 230 may still be owned and operated by supply hub entity 206, but may be structured to provide two apparently separate supply hubs, one for each ERP system 210. The separation, however, may be a logical construct rather than a physical one, where an ERP system 210 has access to only certain servers, parts of servers, and/or data stores within supply hub 230. Supply hub 230 is described below with respect to FIG. 3.

FIG. 3 illustrates a block diagram of a supply hub 300. Supply hub 300 may be a representative embodiment of supply hub 230. In an embodiment, supply hub 300 may be implemented with a cloud computing model. In a cloud computing model, applications and services may be provided as though the applications and data were on a local device, without having to install the applications and/or store the data on a local computer. However, the applications and/or data storage may be implemented across many devices, servers, and data stores, accessible over a communication interface from a local device. In a cloud computing model, supply hub 300 may be physically embodied on one or more servers, and in one or more physical locations. Regardless of physical configuration, supply hub 230 may appear, logically, as one device or system to external entities, such as to ERP systems 210 and client systems 220.

In an embodiment, supply hub 300 may include an ERP application 310. In an embodiment, ERP application 310 may be a representative embodiment of ERP application 212. Alternatively, supply hub 300 may include ERP application support 320. ERP application support 320 may perform various functions as a component of an ERP application without being a stand-alone ERP application. For example, ERP application support 320 may update data in databases, perform calculations, convert data from one format to another, and so forth.

In an embodiment, supply hub 300 may include client accounts 330. Client accounts 330 may be a representative embodiment of client accounts 214. When client accounts 330 are present on supply hub 300, client accounts 214 may be omitted from the ERP system 210. Storing client accounts 330 on supply hub 300 may provide global accessibility to client accounts 330 to multiple ERP systems 210 for one entity.

In an embodiment, supply hub 300 may store ERP data 340. ERP data 340 may be any data used or generated by an ERP application, such as ERP application 310, ERP application 212, or ERP application support 320. ERP data 340 may include, without limitation, inventory data, personnel data, client data, product data, project data, order data, invoice data, key performance indicator (KPI) data, vendor managed inventory (VMI) data, and so forth. ERP data 340 may be stored on one or more data stores, and in various formats, such as databases, text files, spreadsheets, and so forth.

In an embodiment, supply hub 300 may include a business process checker 350 and business processes 360. In an embodiment, business process checker 350 may be a component of ERP application 310 or ERP application support 320. Business processes 360 may be a component of ERP data 340.

Business process checker 350 may examine ERP actions that take place on an ERP system, or between an ERP system 210 and a client system 220, to determine whether the ERP action conforms to the business processes 360. ERP actions for a customer and vendor supply relationship may include, for example and without limitation, viewing an order; placing an order; receiving an order; rejecting an order; changing an order; confirming an order; conditionally confirming an order; receiving an invoice; viewing an invoice; sending an invoice; confirming a shipment; viewing a key performance indicator; viewing vendor managed inventory; and viewing the status of an ERP action.

When an ERP action does not conform to a business process, business process checker 350 may generate an exception. For example, business process checker 350 may compare an original order to the confirmation of the order from a vendor to determine whether the confirmed order is the same as the original order. If the original and confirmed orders differ, for example, if the vendor changed the price of an item, business process checker 350 may generate an exception. The exception in this example may prevent the order from being confirmed, and may prompt the ordering customer to review the confirmed order to approve or reject the change. The embodiments are not limited to these examples.

The components of supply hub 300, e.g. ERP application 310 or ERP application support 320, client accounts 330, ERP data 340, business process checker 350 and business processes 360, may be distributed across multiple devices and/or physical locations. The components may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

FIG. 4 illustrates a block diagram of a client system 400. The client system 400 may be representative of client system 120 or 220. Client system 400 may represent one of multiple electronic devices owned by a client entity, e.g. client entity 204, or operated on behalf of a client entity.

Client system 400 may include a client application 410. Client application 410 may be a software application comprised of executable program instructions. In an embodiment, client application 410 may have a primary function that is not related to ERP applications. For example, client application 410 may be a customer relations management (CRM) application, such as, but not limited to, MICROSOFT DYNAMICS CRM®. A CRM application generally provides functionality that manages sales, marketing, and service interactions between a business entity and its clients, customers, and potential customers. Client application 410 may generally be an application that the client entity has installed on client system 400 for a primary purpose other than performing ERP actions.

In an embodiment, client system 400 may include an add-on application 412. Add-on application 412 may be installed to add ERP functionality to the existing client application 410. Add-on application 412 may work within the user interface of the existing client application 410 to present the ability to perform ERP actions. In an embodiment add-on application 412 may verify that an ERP action received from the ERP system conforms to a business process. The business process may be a business process local to the entity operating client system 400, or may be a business process 360. When an ERP action does not conform to a business process, add-on application 412 may generate a notification that an exception has occurred when the ERP action, and sending the notification to the ERP system.

In an embodiment, an ERP system 110, 210 may request from the client entity information about what client applications 410 the client system 400 already has, when an ERP owning entity is forming a partnership with a client entity. The request may include a specific list of client applications 410 for which the ERP system 110, 210 has add-on applications. When the client entity selects an existing client application 410, the ERP system 110, 210 may send add-on application 412 for the selected client application 410 to client system 400. Client system 400 may then install add-on application 412. Providing add-on application 412 to client system 400 provides the ability for client system 400 to interact electronically with ERP system 110, 210 using an existing application, without the cost and time of having to set-up an EDI system.

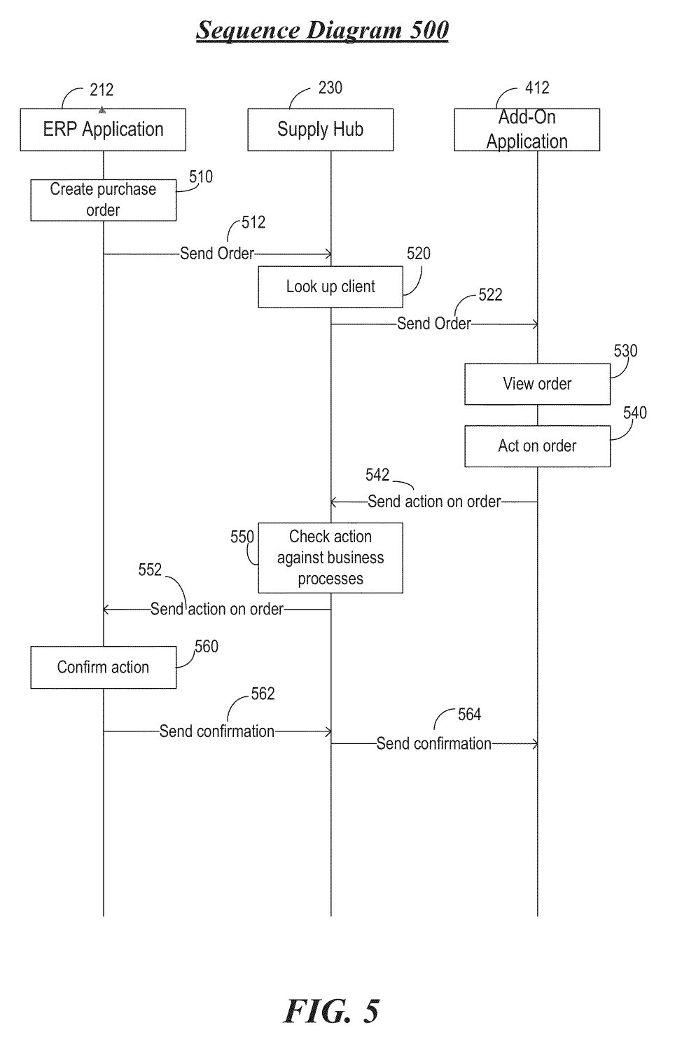

FIG. 5 illustrates a sequence diagram 500. Sequence diagram 500 illustrates an example of a set of ERP actions taken in system 200 among ERP application 212, supply hub 230, and add-on application 412. In sequence diagram 500, time begins at the top of the figure and increases from the top of the figure towards the bottom of the figure. In the illustrated example, ERP application 212 is operated by a purchasing entity (the customer), and add-on application 412 is operated by a vendor entity (the vendor). Supply hub 230 may be operated by the customer, or by a third-party on behalf of the customer.

ERP application 212 performs an ERP action of creating a purchase order (510). For example, a user may use an interface of ERP application 212 to create a new purchase order object, and may assign values within the purchase order object, such as the selected vendor, items to order, quantities to order, prices of the items, and a desired delivery date. When the purchase order is complete, it may be sent to supply hub 230 as transmission 512. Sending the purchase order may include sending the purchase order object to supply hub 230, or may include sending the assigned values to supply hub 230.

Supply hub 230 may receive transmission 512 and may, if needed, look up (520) information about the client, the selected vendor. For example, supply hub 230 may look up what type of client application 410 the vendor is using, and by extension, what add-on application 412 is being used. If needed, supply hub 230 may format the purchase order according to the add-on application in use. For example, if the purchase order is in a table format, supply hub 230 may convert the table format into an extensible markup language (XML) formatted document. In an embodiment, the purchase order may be stored on supply hub 230 as part of ERP data 340, for example, as a purchase order object or a database entry. The embodiments are not limited to these examples.

Supply hub 230 may then send the purchase order to add-on application 412 as transmission 522. In an embodiment, the purchase order itself, or as formatted by supply hub 230, may be sent. In another embodiment, a link to the purchase order stored on supply hub 230 may be sent. In another embodiment, the purchase order may be fetched by add-on application 412 from supply hub 230 when the CRM functions are accessed.

A user at the client system 220 may use add-on application 412 to view the order (530). In an embodiment, when add-on application 412 is added onto a CRM client application, the purchase order may appear in a list of open orders in a supply hub section within the CRM application. Add-on application 412 may also include a user interface area where received purchase orders may be viewed.

The purchase order may be acted on (540) by add-on application 412. Acting upon the purchase order may include performing another ERP action. For example, the purchase order may be accepted or confirmed, rejected, or modified and accepted in modified form. If, for example, the vendor does not have enough of an ordered item to fulfill the purchase order, the vendor may change the ordered amount to reflect the number of the items that are available, and then accept the purchase order with the modified amount. When the action on the order (530) is complete, add-on application 412 may send the action, or the acted-upon order, back to supply hub 230 in transmission 542.

Supply hub 230 may receive the action, and may check the action against the business processes (550). For example, business process checker 350 may determine whether the order has been accepted, rejected, or modified. When an order has been modified, a business process 360 may specify that the purchase order cannot be automatically confirmed, but needs to be approved by the customer. If the purchase order was modified, then supply hub 230 may generate an exception and may send the action back to ERP application 212 in transmission 552 for review by the customer.

ERP application 212 may receive the action as a conditional confirmation, and may prompt a user to accept or reject the conditional confirmation. The user may use ERP application 212 to confirm or reject the action (560). The confirmation/rejection may be sent to supply hub 230 in transmission 562. If the conditional confirmation is accepted, supply hub 230 may remove the exception and may update ERP system 210 and/or ERP data 340 to modify the purchase order and indicate that the purchase order is accepted.

Supply hub 230 may send the confirmation/rejection to add-on application 412 in transmission 564. Add-on application 412 may receive the confirmation/rejection transmission 564 and may proceed to fulfilling the purchase order.

Sequence diagram 500 represents one of many possible interactions between an ERP application and a client add-on application via a supply hub. The embodiments are not limited to the illustrated example.

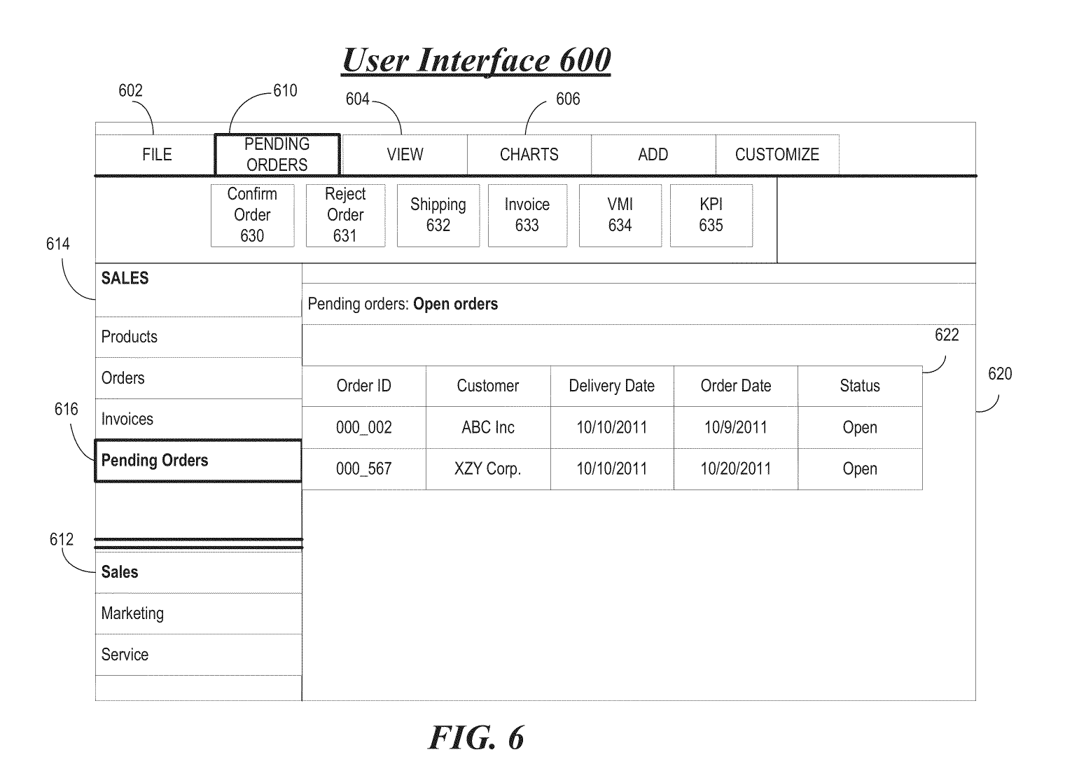

FIG. 6 illustrates an embodiment of a user interface 600. User interface 600 may include a part of a user interface of client application 410, with one or more additional components added by add-on application 412. In the illustrated example, user interface (UI) 600 is for a CRM application.

UI 600 may arrange functions of client application 410 into tabs, such as file tab 602, view tab 604, and charts tab 606. Add-on application 412 may add a tab, e.g. pending orders tab 610, to permit access to ERP functions within client application 410. In FIG. 6, the pending orders tab 610 is selected and UI 600 shows a pending orders section.

UI 600 may provide access points to various ERP functions. For example, in the pending orders section of UI 600, a selection pane 612 may provide the option to select sales. When sales is selected in selection pane 612, a sub-pane 614 may be shown with sales-related options. When pending orders 616 is selected, a list of open orders may be shown in viewing pane 620.

Viewing pane 620 may show open orders, for example, as a table 622. Table 622 may have a row for each open order. Each row may include relevant information about an order, including, for example, an order ID, the customer that made the order, a requested delivery date, an order date, and a status of the order. Additional or alternate information may be shown.

In an embodiment, a specific pending order may be selected, for example, by using an input device, e.g. a single click with a mouse on a row, or by selecting a check box (not shown) next to an order row. A pending order may be opened for viewing by selecting the order and choosing an “open” option from a menu, by double-clicking a pending order, and so forth. A listing of pending orders may be displayed in other formats, the embodiments are not limited to this example.

UI 600 may provide selectable buttons in the pending orders section to confirm an order 630, reject an order 631, arrange shipping for an order 632, generate an invoice for an order 633, view vendor managed inventory (VMI) 634, and view key performance indicators (KPI) 635. When an order is selected in viewing pane 620, selecting the button to confirm the order 630 may confirm the order. Selecting a button to view VMI 634 or KPI 635 may open a UI view pertaining to the button. In an embodiment, the buttons pertaining to a specific order, e.g. buttons 630, 631, 632, and 633 may be inactive until an order is selected.

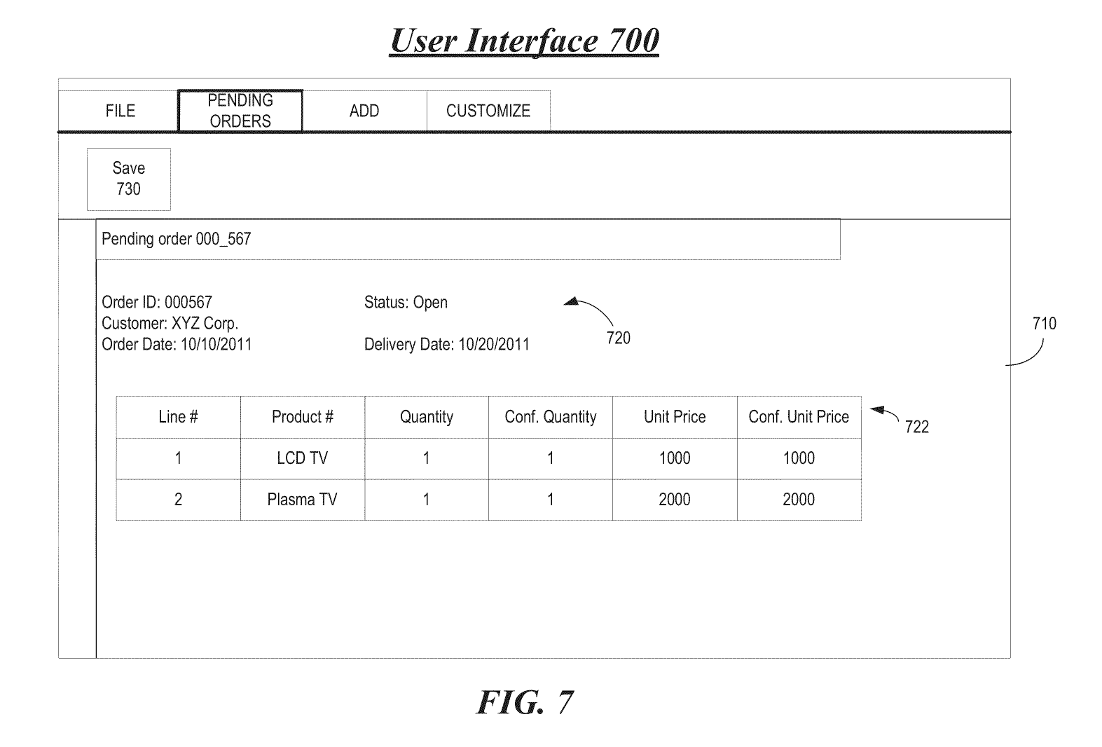

FIG. 7 illustrates an embodiment of a user interface (UI) 700. UI 700 may be a view of UI 600 a pending order in viewing pane 620 is selected. UI 700 may provide an order view pane 710. Order view pane 710 may be a pane within UI 700 or may be a separate object, such as a window, displayed in front of UI 700.

Order pane 710 may show general information about the purchase order in order information area 720. Order information area 720 may show, for example, the order ID, customer name, order date, status and requested delivery date. Additional or alternate information may be shown. The information in order information area 720 may also be presented in other formats, such as in one line, separate fields, and so forth.

Order pane 710 may show the details of the purchase order in a table 722. In an embodiment, some of the data fields in table 722 may be editable by the vendor. For example, the confirmed quantity of product “LCD TV” may be changed from 1 to another number Likewise, the confirmed unit price may be changed from 1000 to another number. In an embodiment, each line item may be selected and opened in a new view, where changes to quantities and prices may be made. The purchase order may be shown in other formats, such as in a form, a text document, a web page, and so forth.

When the vendor has finished viewing, and possibly modifying, the purchase order, selecting the save button 730 may save the changes and close order pane 710, returning to the view of open orders in viewing pane 620. From viewing pane 620, the saved order may then be confirmed, e.g. with confirm order button 630. The purchase order as confirmed may be sent to supply hub 230 for checking against business processes 360 and for distribution to the ERP system of the customer. Alternatively, if reject order button 631 is selected, add-on application 412 may send a message to supply hub 230 that the order was rejected. Supply hub 230 may then notify the ERP system of the customer that the order was rejected.

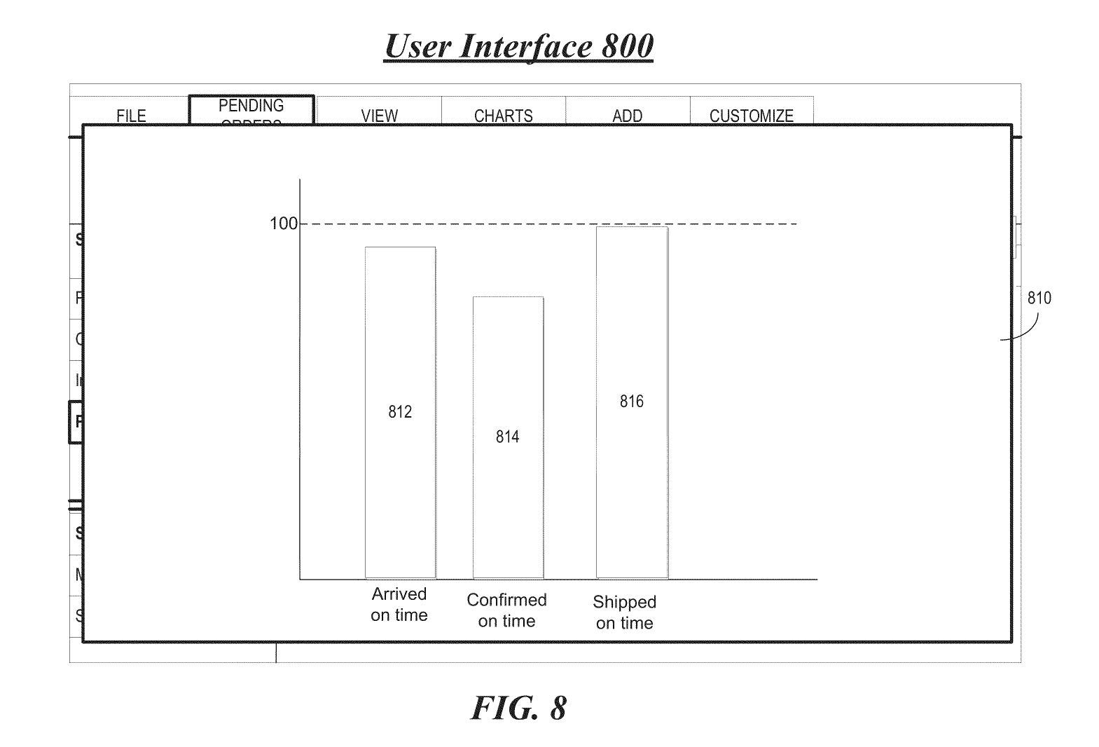

FIG. 8 illustrates an embodiment of a user interface (UI) 800. UI 800 may be a view of UI 600 when KPI button 635 is selected. UI 800 may provide a KPI view pane 810. KPI view pane 810 may be a pane within UI 800 or may be a separate object, such as a window, displayed in front of UI 800.

KPI view pane 810 may show, graphically, a variety of key performance indicators (KPIs). For example, KPI view pane 810 may show a bar graph showing the percentage of: orders that arrive on time at a customer (bar 812), orders that are confirmed on time (bar 814), and orders that are shipped on time (bar 816). Other examples of KPIs related to a supply relationship that may be shown include orders that were fully confirmed, matching delivery, matching shipments, and so forth.

In an embodiment, a bar, e.g. bar 812, in KPI view pane 810 may be selected. When selected, KPI view pane 810 may change to show another graph, or may open a new KPI view pane, that illustrates the KPI for the selected bar in greater detail, for example, the percentage of orders that arrived on time, separated by month. A bar for a specific month may be selected to obtain the KPI data per week in the selected month. KPI data may be presented in other forms not limited to this example, such as with line graphs, histograms, pie charts, and so forth.

In an embodiment, KPI data may be stored at supply hub 230. Add-on application 412 may fetch the KPI data when KPI button 635 is selected.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

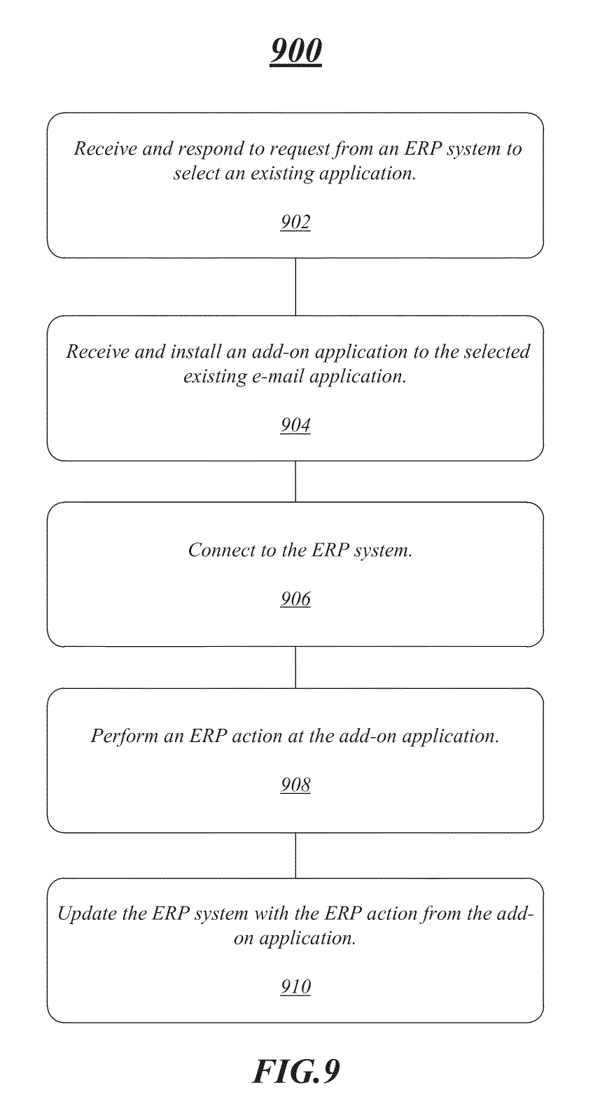

FIG. 9 illustrates one embodiment of a logic flow 900. The logic flow 900 may be representative of some or all of the operations executed by one or more embodiments described herein. Logic flow 900 may be performed by various systems and/or devices and may be implemented as hardware, software, and/or any combination thereof, as desired for a given set of design parameters or performance constraints. For example, the logic flow 900 may be implemented by a logic device (e.g., processor) and/or logic (e.g., threading logic) comprising instructions, data, and/or code to be executed by a logic device. For purposes of illustration, and not limitation, the logic flow 900 is described with reference to FIGS. 1-4. The embodiments are not limited in this context.

In the illustrated embodiment shown in FIG. 9, the logic flow 900 may receive and respond to a request from an ERP system to select an existing application at block 902. For example, ERP system 110, 210 may request that client system 120, 220 select an application already installed on client system 120, 220. In an embodiment, the request may have specified applications to select from and the response may include one or more selections of the applications that the client system 120, 220 has installed. In another embodiment, client system 120, 220 may respond with one or more applications that are installed without selecting from a list. In an embodiment, the selected existing application may be a CRM application. The ERP system 110, 210 may use the response to select an add-on application 412 to send to client system 120, 220.

The logic flow 900 may receive and install an add-on application to the selected CRM application at block 904. For example, ERP system 110, 210 may send an add-on application 412 for the selected CRM application. In an embodiment, the add-on application 412 may be sent as an executable application, that, when executed, performs the installation onto the existing CRM application 410.

The logic flow 900 may connect to the ERP system at block 906. For example, client application 410, using add-on application 412, may connect to ERP system 110, 210. The connection may be over a network, such as the Internet. In an embodiment, logic flow 900 may connect to a supply hub, such as supply hub 230, 300, from add-on application 412. In an embodiment, the connection may enable the exchange of data between ERP system 110, 210, and client system 120, 220.

The logic flow 900 may perform an ERP action at the add-on application at block 908. An ERP action may include, for example and without limitation: placing an order; receiving an order; rejecting an order; changing an order; confirming an order; conditionally confirming an order; receiving an invoice; sending an invoice; confirming a shipment; viewing a key performance indicator; viewing vendor managed inventory; and viewing the status of an ERP action. Add-on application 412 may add a user interface to client application 410, or use an existing user interface, to present access points to perform ERP actions within client application 410. In an embodiment, the ERP action performed in block 908 may be in response to an ERP action received from the ERP system. For example, if client system 120, 220 receives a purchase order, the ERP action performed at add-on application 412 may include rejecting the purchase order, confirming the order, or changing the order.

The logic flow 900 may update the ERP system with the ERP action from the add-on application at block 910. For example, if add-on application 412 modified ERP data, e.g. changing an order, or moves a supply relationship process to a next step, e.g. confirming an order, the ERP system 110, 210 will receive the update caused by the ERP action at the add-on application 412. In an embodiment, the ERP action performed at add-on application 412 may be sent to supply hub 230, 300, which may then update ERP system 110, 210.

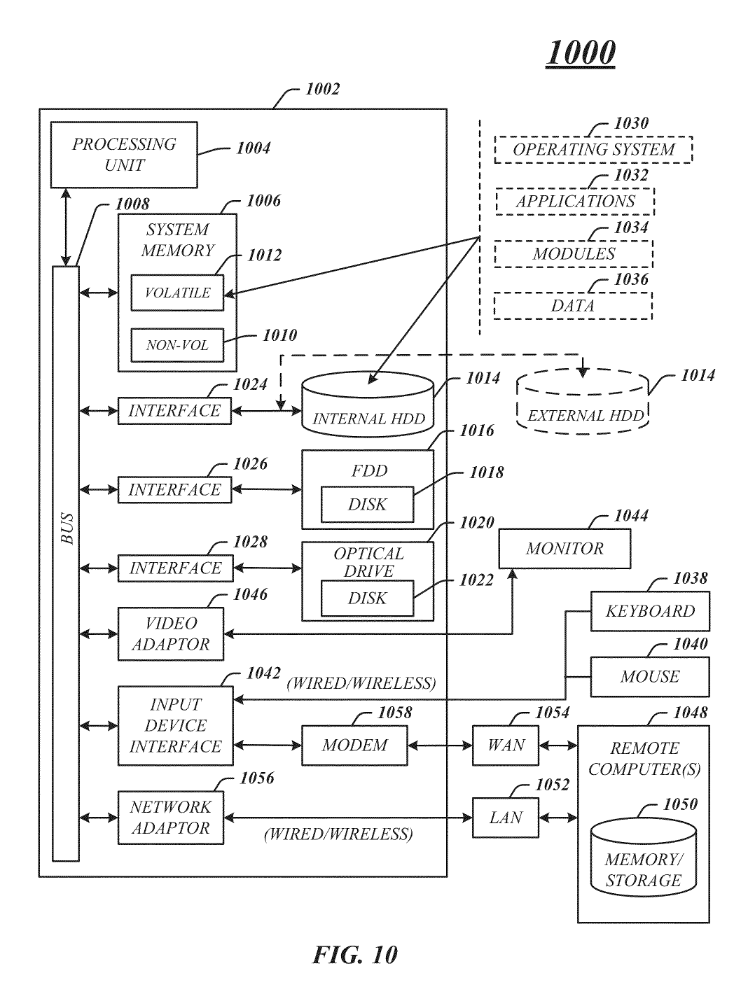

FIG. 10 illustrates an embodiment of an exemplary computing architecture 1000 suitable for implementing various embodiments as previously described. The computing architecture 1000 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1000.

As shown in FIG. 10, the computing architecture 1000 comprises a processing unit 1004, a system memory 1006 and a system bus 1008. The processing unit 1004 can be any of various commercially available processors. Dual microprocessors and other multi-processor architectures may also be employed as the processing unit 1004. The system bus 1008 provides an interface for system components including, but not limited to, the system memory 1006 to the processing unit 1004. The system bus 1008 can be any of several types of bus structure that may further interconnect to a memory bus (with or without a memory controller), a peripheral bus, and a local bus using any of a variety of commercially available bus architectures.

The system memory 1006 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 10, the system memory 1006 can include non-volatile memory 1010 and/or volatile memory 1012. A basic input/output system (BIOS) can be stored in the non-volatile memory 1010.

The computer 1002 may include various types of computer-readable storage media, including an internal hard disk drive (HDD) 1014, a magnetic floppy disk drive (FDD) 1016 to read from or write to a removable magnetic disk 1018, and an optical disk drive 1020 to read from or write to a removable optical disk 1022 (e.g., a CD-ROM or DVD). The HDD 1014, FDD 1016 and optical disk drive 1020 can be connected to the system bus 1008 by a HDD interface 1024, an FDD interface 1026 and an optical drive interface 1028, respectively. The HDD interface 1024 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1010, 1012, including an operating system 1030, one or more application programs 1032, other program modules 1034, and program data 1036. The one or more application programs 1032, other program modules 1034, and program data 1036 can include, for example, the ERP application 112, business process checker 150, client application 410, and add-on application 412.

A user can enter commands and information into the computer 1002 through one or more wire/wireless input devices, for example, a keyboard 1038 and a pointing device, such as a mouse 1040. Other input devices may include a microphone, an infra-red (IR) remote control, a joystick, a game pad, a stylus pen, touch screen, or the like. These and other input devices are often connected to the processing unit 1004 through an input device interface 1042 that is coupled to the system bus 1008, but can be connected by other interfaces such as a parallel port, IEEE 1394 serial port, a game port, a USB port, an IR interface, and so forth.

A monitor 1044 or other type of display device is also connected to the system bus 1008 via an interface, such as a video adaptor 1046. In addition to the monitor 1044, a computer typically includes other peripheral output devices, such as speakers, printers, and so forth.

The computer 1002 may operate in a networked environment using logical connections via wire and/or wireless communications to one or more remote computers, such as a remote computer 1048. The remote computer 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wire/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the LAN 1052 through a wire and/or wireless communication network interface or adaptor 1056. The adaptor 1056 can facilitate wire and/or wireless communications to the LAN 1052, which may also include a wireless access point disposed thereon for communicating with the wireless functionality of the adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wire and/or wireless device, connects to the system bus 1008 via the input device interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

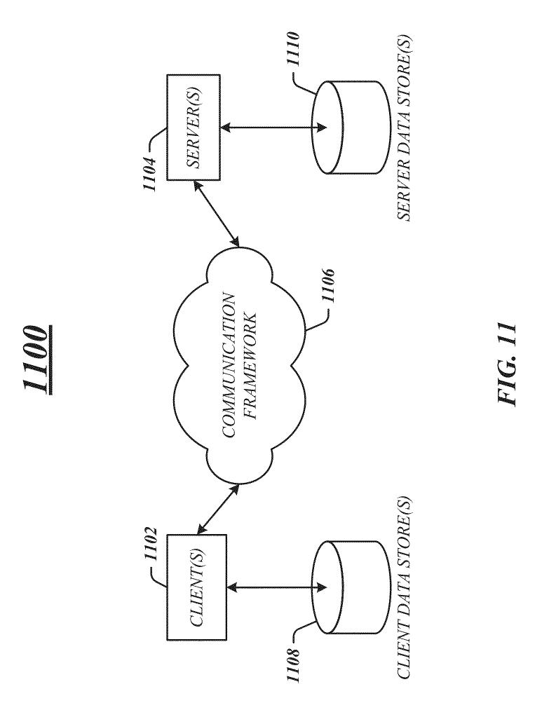

FIG. 11 illustrates a block diagram of an exemplary communications architecture 1100 suitable for implementing various embodiments as previously described. The communications architecture 1100 includes various common communications elements, such as a transmitter, receiver, transceiver, radio, network interface, baseband processor, antenna, amplifiers, filters, and so forth. The embodiments, however, are not limited to implementation by the communications architecture 1100.

As shown in FIG. 11, the communications architecture 1100 comprises includes one or more clients 1102 and servers 1104. The clients 1102 may implement the client systems 120, 220, 400. The servers 1104 may implement the server ERP systems 110, 210 and the supply hub 230, 300. The clients 1102 and the servers 1104 are operatively connected to one or more respective client data stores 1108 and server data stores 1110 that can be employed to store information local to the respective clients 1102 and servers 1104, such as cookies and/or associated contextual information.

The clients 1102 and the servers 1104 may communicate information between each other using a communication framework 1106. The communications framework 1106 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 1102 and the servers 1104 may include various types of standard communication elements designed to be interoperable with the communications framework 1106, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 1102 and a server 1104 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
installing an add-on application to an existing customer relations management (CRM) application on a client computing device;
connecting to an enterprise resource planning (ERP) system with the add-on application;
receiving an ERP action from the ERP system at the add-on application; and
performing a second ERP action, in response to the received ERP action, at the ERP system by the add-on application.

2. The method of claim 1, wherein an ERP action comprises at least one of:
placing an order;
receiving an order;
rejecting an order;
changing an order;
confirming an order;
conditionally confirming an order;
receiving an invoice;
sending an invoice;
confirming a shipment;
viewing a key performance indicator;
viewing vendor managed inventory; and
viewing the status of an ERP action.

3. The method of claim 1, further comprising;
receiving a request for a selection of an existing communication application from the ERP system;
providing a selection of the existing CRM application to the ERP system; and
receiving the add-on application for the selected existing CRM application from the ERP system.

4. The method of claim 1, further comprising:
receiving a notification from the ERP system at the add-on application when an exception to the ERP action performed at the add-on application occurs.

5. The method of claim 1, further comprising:
connecting to a supply hub in communication with the ERP system; and
communicating an ERP action to the supply hub.

6. The method of claim 5, further comprising:
receiving an ERP action from the ERP system via the supply hub.

7. The method of claim 1, further comprising:
verifying that an ERP action received from the ERP system conforms to a business process;
generating a notification that an exception has occurred when the ERP action does not conform to the business process; and
sending the notification to the ERP system.

8. The method of claim 1, further comprising:
displaying ERP data in a user interface of the existing CRM application.

9. An article comprising a storage medium containing instructions that when executed cause a client computing device system to:
receive an enterprise resource planning (ERP) action from a supply hub at an add-on application installed on a customer relations management (CRM) application on the client computing device;
act on the received ERP action with a second ERP action by the add-on application; and
send the second ERP action to the supply hub.

10. The article of claim 9, the storage medium further containing instructions that when executed cause the system to:
perform a third ERP action at the add-on application; and
send the third ERP action to the supply hub.

11. The article of claim 9, wherein an ERP action comprises at least one of:
placing an order;
receiving an order;
rejecting an order;
changing an order;
confirming an order;
conditionally confirming an order;
receiving an invoice;
sending an invoice;
confirming a shipment;
viewing a key performance indicator;
viewing vendor managed inventory; and
viewing the status of an ERP action.

12. The article of claim 9, the storage medium further containing instructions that when executed cause the system to:
verify that an ERP action received from the supply hub conforms to a business process;
generating a notification that an exception has occurred when the ERP action does not conform to the business process; and
sending the notification to the supply hub.

13. The article of claim 9, the storage medium further containing instructions that when executed cause the system to:
display ERP data in a user interface of the existing CRM application.

14. The article of claim 9, the storage medium further containing instructions that when executed cause the system to:
modify ERP data at the add-on application; and
update the supply hub with the modified data.

15. An apparatus, comprising:
a processing unit;
a client customer relations management (CRM) application arranged for execution on the processing unit;
an add-on application installed on the client CRM application, executing on the processing unit to:
receive an enterprise resource planning (ERP) action from an ERP system via a supply hub;
act on the ERP action with a second ERP action; and
send the second ERP action to the ERP system via the supply hub.

16. The apparatus of claim 15, the add-on application further operative to:
perform a third ERP action at the add-on application; and
send the third ERP action to the ERP system via the supply hub.

17. The apparatus of claim 15, the add-on application further operative to:
verify that an ERP action received from the ERP system via the supply hub conforms to a business process;
generate a notification that an exception has occurred when the ERP action does not conform to the business process; and
send the notification to the ERP system via the supply hub.

18. The apparatus of claim 15, the add-on application further operative to:
display ERP data in a user interface of the existing CRM application.

19. The apparatus of claim 15, the add-on application further operative to:
modify ERP data at the add-on application; and
update the supply hub with the modified data.

20. The apparatus of claim 15, wherein an ERP action comprises at least one of:
placing an order;
receiving an order;
rejecting an order;
changing an order;
confirming an order;
conditionally confirming an order;
receiving an invoice;
sending an invoice;
confirming a shipment;
viewing a key performance indicator;
viewing vendor managed inventory; and
viewing the status of an ERP action.
